(19) United States
(12) Patent Application Publication
(10) Pub. No.: US 2012/0282013 A1
(43) Pub. Date: Nov. 8, 2012

(54) SCAFFOLDING BEAM COUPLER

(76) Inventor: Luc BÉLAND, Chicoutimi (CA)

(21) Appl. No.: 13/464,496

(22) Filed: May 4, 2012

Related U.S. Application Data
(60) Provisional application No. 61/482,644, filed on May 5, 2011.

(51) Int. Cl. E04G 7/00; B23P 11/00

(52) U.S. Cl. 403/49; 29/897.31; 29/428

(57) ABSTRACT

A scaffolding beam coupler for coupling a scaffolding pipe and a beam having a flange with two flange sections, the scaffolding beam coupler comprising: at least two spaced-apart jaws engageable with the flange of the beam, each one of the flange sections being engageable with a respective one of the jaws; and at least two transversal members, each one of the transversal members being connected to two of the spaced-apart jaws and at least two of the transversal members being spaced-apart from one another and preventing the connected jaws from moving apart when coupled with the beam. There is also provided a method for manufacturing a scaffolding beam coupler and a method for coupling a scaffolding pipe and a beam.

### CROSS-REFERENCE TO RELATED APPLICATIONS

This application claims priority under 35 USC §119(e) of U.S. provisional patent application 61/482,644 filed on May 5, 2011, the specification of which is hereby incorporated by reference.

### TECHNICAL FIELD

The technical field relates to scaffolding couplers and, more particularly, to scaffolding couplers for beams. It also relates to a method for coupling scaffolding pipes and beams.

### BACKGROUND

Scaffolding couplers are intended to releasably couple together a scaffolding pipe (or tube) with at least other scaffolding pipe or other structural component such as a beam. Scaffolding beam couplers or locks engage together a scaffolding tube with a beam. More particularly, they include a first releasable coupling device for engaging the outer surface of a scaffolding pipe and a second releasable coupling device for engaging a flange of a beam, such as a steel beam. Typically, the scaffolding tube is held at right angle to the beam.

The second releasable coupling device that is engageable with the flange of the beam typically consists of jaws (or projections) having a bore defined therein through which clamping bolts are inserted. The flange of the beam is inserted between the first coupling device and the jaws and is maintained therebetween by the clamping bolts which apply pressure thereon (or squeeze the flange).

However, the clamping bolt(s) may unscrew or the jaws may move apart due to vibrations, amongst other reasons, causing the scaffolding tube and the beam to detach from one another. Damages can occur due to unexpected release of one of the scaffolding tube and the beam.

### BRIEF SUMMARY OF THE INVENTION

It is therefore an aim of the present invention to address the above mentioned issues.

According to a general aspect, there is provided a scaffolding beam coupler for coupling a scaffolding pipe and a beam having a flange with two flange sections, the scaffolding beam coupler comprising: two spaced-apart jaws engageable with the flange of the beam, each one of the jaws of the flange being engageable with a respective one of the flange sections; and at least two transversal members, each one of the transversal members being secured to both jaws and at least two of the transversal members being spaced-apart from one another and preventing the two jaws from moving apart when coupled with the beam.

According to another general aspect, there is provided a method for manufacturing a scaffolding beam coupler comprising: providing a scaffolding beam coupler including a scaffolding pipe coupling device and a beam coupling device including two spaced-apart jaws engageable with a flange of the beam; and connecting at least two transversal members to the spaced-apart jaws, each one of the transversal members being connected to both jaws and being spaced apart from one another and preventing the two jaws from moving apart when engaged with the flange of the beam.

According to still another general aspect, there is provided a method for coupling a scaffolding pipe and a beam having a flange, the method comprising: providing a scaffolding beam coupler comprising a scaffolding pipe coupling device, a beam coupling device including two spaced-apart jaws engageable with a flange of the beam, and at least two transversal members, each one of the transversal members being secured to the spaced-apart jaws and at least two of the transversal members being spaced-apart from one another and preventing the two jaws from moving apart when engaged with the flange; engaging the scaffolding pipe with the scaffolding pipe coupling device; and engaging the flange of the beam between both spaced-apart jaws.

According to a general aspect, there is provided a scaffolding beam coupler for coupling a scaffolding pipe and a beam having a flange with two flange sections, the scaffolding beam coupler comprising: a beam coupling device including at least two spaced-apart jaws engageable with the flange of the beam, each one of the spaced-apart jaws being engageable with a respective one of the flange sections for securing the beam to the beam coupling device; and at least two transversal members, each one of the transversal members being connected to two of the spaced-apart jaws and extending therebetween, and at least two of the transversal members being spaced-apart from one another and preventing the connected spaced-apart jaws from moving apart when coupled with the beam.

According to still another general aspect, there is provided a method for manufacturing a scaffolding beam coupler comprising: providing a scaffolding beam coupler including a scaffolding pipe coupling device configured for engaging and securing a scaffolding pipe and a beam coupling device including at least two spaced-apart jaws engageable with a flange of a beam; and connecting at least two transversal members to the jaws, each one of the transversal members being connected to two of the spaced-part jaws and being spaced apart from one another and preventing the jaws from moving apart when engaged with the beam.

According to a further general aspect, there is provided a method for coupling a scaffolding pipe and a beam having a flange, the method comprising: providing a scaffolding beam coupler comprising a scaffolding pipe coupling device, a beam coupling device including at least two spaced-apart jaws engageable with the flange of the beam, and at least one transversal member connected to two of the spaced-apart jaws and preventing the connected jaws from moving apart when engaged with the beam; engaging the scaffolding pipe with the scaffolding pipe coupling device; and engaging the flange of the beam between the spaced-apart jaws.

According to a further general aspect, there is provided a scaffolding beam coupler for coupling a scaffolding pipe and a beam having a flange with two flange sections, the scaffolding beam coupler comprising two scaffolding beam coupler sections, each having a beam coupling device with at least one jaw engageable with one of the flange sections of the beam for securing the beam to the scaffolding beam coupler, the at least one jaw of one of the scaffolding beam coupler sections being spaced-apart from the at least one jaw of the other one of the scaffolding beam coupler sections, and the two scaffolding beam coupler sections being connected together for preventing the spaced-apart jaws from moving apart when coupled with the beam.

### BRIEF DESCRIPTION OF THE DRAWINGS

FIG. 1 is a front elevation view of a scaffolding beam coupler in accordance with an embodiment;

FIG. 2 is a side elevation view of one section of the scaffolding beam coupler shown in FIG. 1;

FIG. 3 is a side elevation view of the scaffolding beam coupler shown in FIG. 1 engaged with a scaffolding pipe and an I-beam;

FIG. 4 is a sectional view of the scaffolding beam coupler taken along cross-section lines IV-IV of FIG. 3, wherein the scaffolding beam coupler is engaged with the scaffolding pipe and the I-beam; and

FIG. 5 is a sectional view of the scaffolding beam coupler taken along cross-section lines V-V of FIG. 3, wherein the scaffolding beam coupler is engaged with the scaffolding pipe and the I-beam.

It will be noted that throughout the appended drawings, like features are identified by like reference numerals.

### DETAILED DESCRIPTION

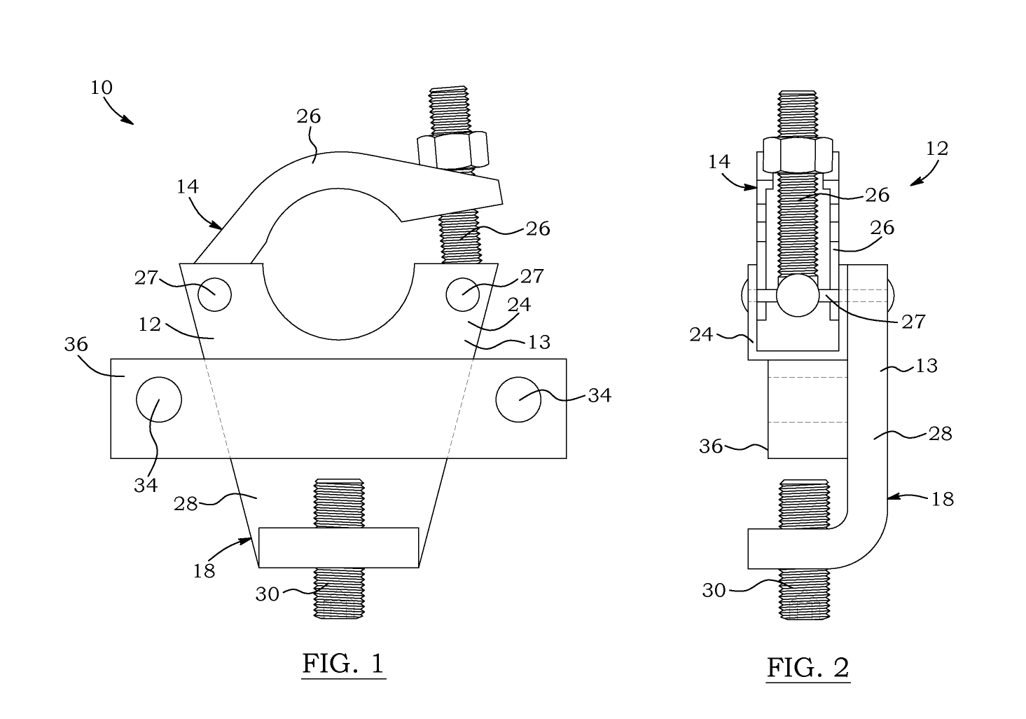

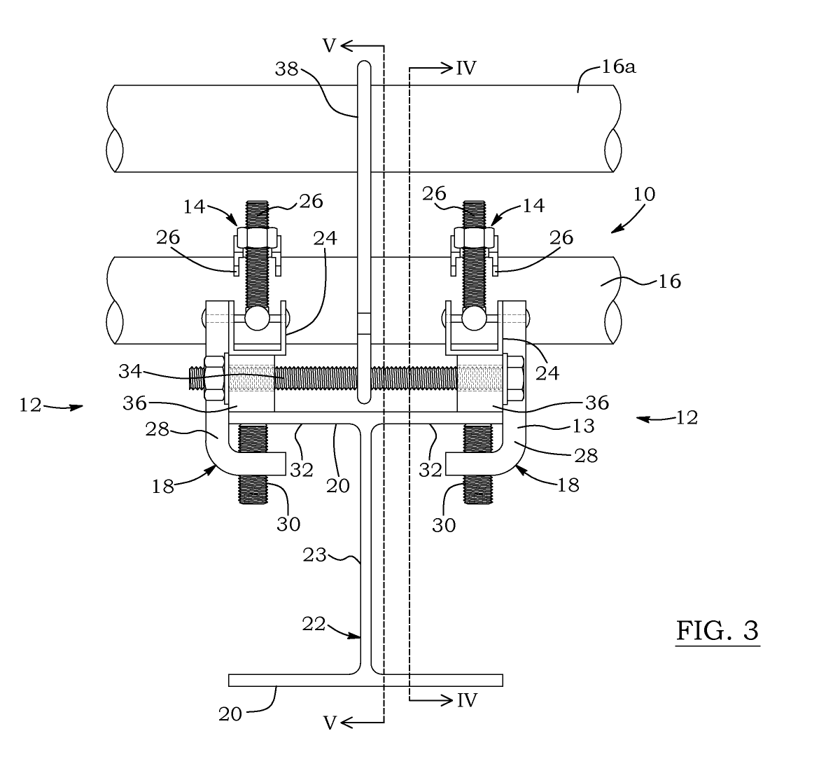

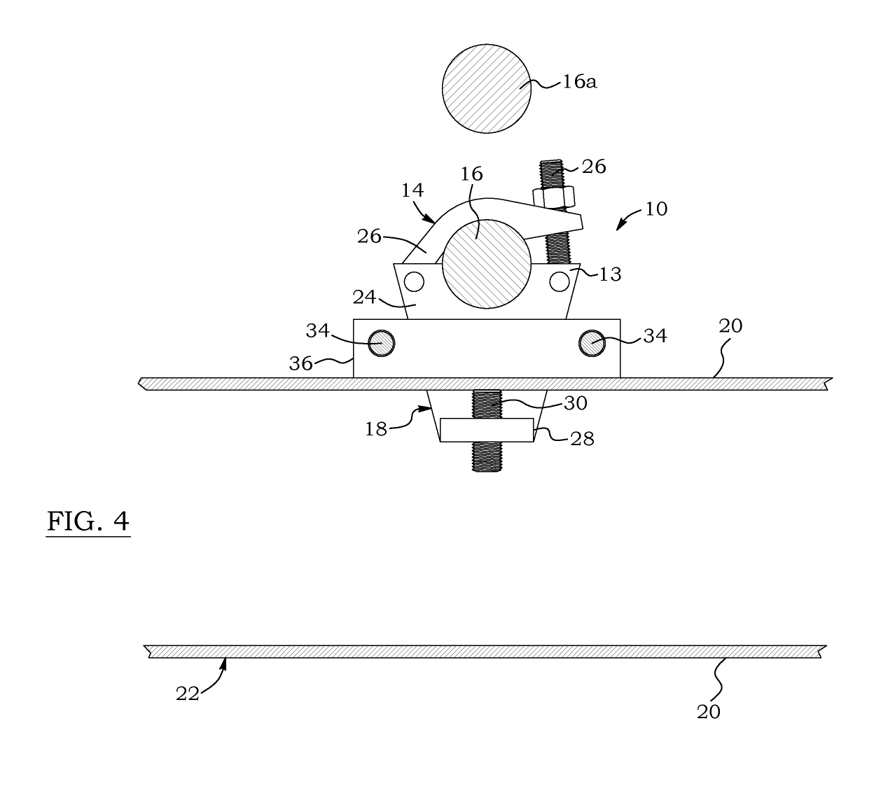

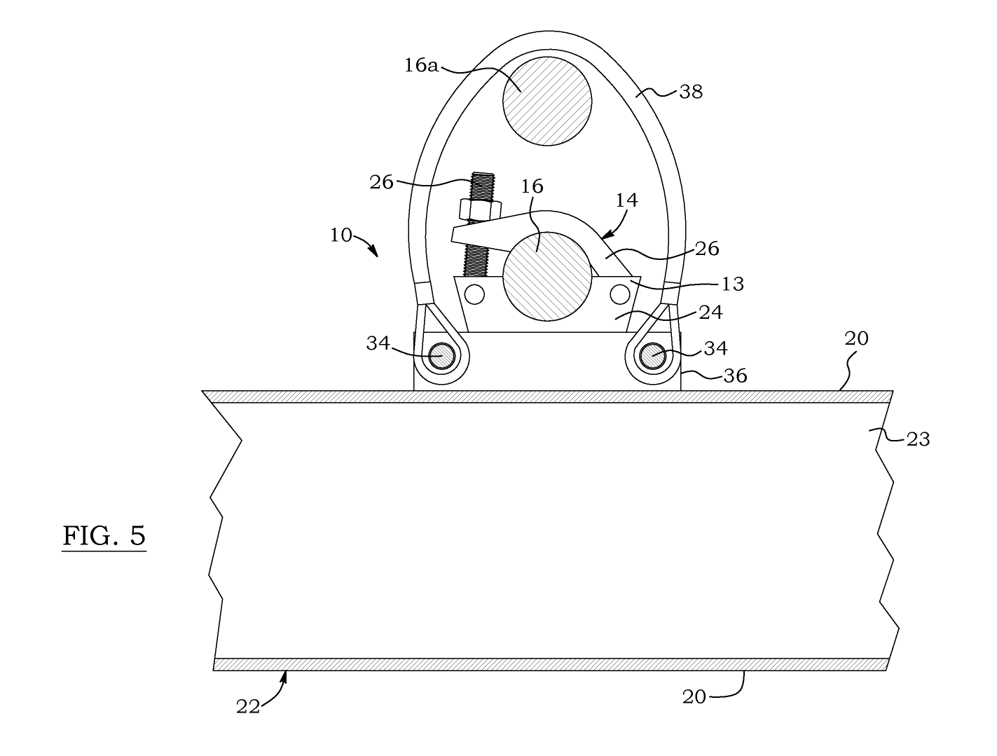

Referring now to the drawings and, more particularly, referring to FIGS. 1 to 5, there is shown an embodiment of a scaffolding beam coupler 10. The scaffolding beam coupler 10 has two spaced-apart sections 12 (FIG. 3). Each section 12 of the scaffolding beam coupler 10 has a body 13 including a scaffolding pipe coupling device 14, engageable with an outer surface of a scaffolding pipe 16 (or scaffolding tube), and a beam coupling device 18, engageable with a flange 20 of a beam 22 (see FIG. 3). The scaffolding beam coupler 10 and the beam coupling device 18 are connected together through fasteners or welded together, for instance. In the embodiment shown, the scaffolding pipe coupling device 14 and the beam coupling device 18 are configured to secure the scaffolding pipe 16 and the beam 22 at right angle, i.e. the longitudinal axis of the scaffolding pipe 16 extends substantially perpendicularly to the longitudinal axis of the beam 22. However, one skilled in the art will appreciate that, in an alternative embodiment, the scaffolding pipe coupling device 14 and the beam coupling device 18 can be configured to secure the scaffolding pipe 16 and the beam 22 in a substantially parallel configuration or at any oblique angle, i.e. any configuration defined between the parallel and the perpendicular configurations.

One skilled in the art will appreciate that the scaffolding pipe 16 is a component of a scaffold frame (not shown) including a plurality of components connected together.

In the embodiment shown, the beam 22 is an I-beam, also known as H-beams, W-beams (for “wide flange”), rolled steel joist (RSJ), or double-T, with an I- or H-shaped cross-section. One skilled in the art will appreciate that other types of suitable beams can be secured to the beam coupling device 18. The I-beam 22 has a web 23 and two flanges 20, extending at opposed ends of the web 23.

One skilled in the art will appreciate that, in an alternative embodiment (not shown), the scaffolding beam coupler 10 can include one or more scaffolding pipe coupling device(s) 14. Thus, the scaffolding beam coupler 10 can include only one scaffolding pipe coupling device 14 for both sections 12 or, as in the embodiment shown, the scaffolding beam coupler 10 includes two scaffolding pipe coupling devices 14 (see FIG. 3), spaced-apart from one another but connected together, as it will be described in more details below.

Each one of the scaffolding pipe coupling device 14 includes a scaffolding clamp designed to engage an outer surface of the scaffolding pipe 16 and secure the scaffolding pipe 16. More particularly, the clamp includes a central body 24 extending substantially perpendicularly to the scaffolding pipe 16 engaged with the scaffolding pipe coupling device 14 and two clamp arms 26 pivotally mounted to the central body 24 for encircling an outer surface of the pipe 16. In the embodiment shown, the central body 24 is substantially U-shaped with a cavity defined in the lateral walls of the central body 24 for receiving a section of the scaffolding pipe 16; however, one skilled in the art will appreciate that the shape of the central body 24 can vary from the embodiment shown in the accompanying figures. Each one of the clamp arms 26 has a proximal end pivotally connected to a respective end of the central body 24 through a hinge and pivots about a respective pivot axis 27. The two clamp arms 26 are engageable with one another and securable together for keeping the pipe 16 locked in position therebetween.

In the embodiment shown, the scaffolding clamp 14 is a bolt clamp wherein a first one of the clamp arms 26 has a U-shaped channel defined in a distal end thereof and the other one of the clamp arms 26 has a threaded distal end. The clamp arm 26 having the threaded distal end is insertable in the U-shaped channel of the other clamp arm 26. The clamp arms 26 are securable together by tightening a nut to the threaded distal end. For releasing the scaffolding pipe 16, the nut is unscrewed (or slackened) and the clamp arm having the threaded distal end can be disengaged from the U-shaped channel defined in the other one of the clamp arms by being pivoted above the pivot axis 27.

In the embodiment shown, the first one of the clamp arms 26 is substantially arch-shaped and defines a cavity for receiving the scaffolding pipe 16 therein. More particularly, the scaffolding pipe 16 is inserted in the cavities defined in the lateral walls of the central body 24 and by the arch shape of the first one of the clamp arms.

In the embodiment shown, the second one of the clamp arms 26 is substantially straight. One skilled in the art will appreciate that the shape of the clamp arms 26 can vary from the embodiment shown in the accompanying drawings.

One skilled in the art will appreciate that other scaffolding pipe coupling device 14 including but not limited to wedge clamps can be used for coupling the beam 22 to the scaffolding pipe 16. The shape, the configuration, and the components of the scaffolding pipe coupling device 14 can vary from the above described embodiment.

As the scaffolding pipe coupling device 14, the beam coupling device 18 has two sections. Each section is engageable with a respective flange section 32 of the beam 22 on a respective side of the web 23. The flange sections 32 are the sections of the flange 20 that extend on each side of the web 23. Each section of the beam coupling device 18 includes an L-shaped jaw 28 having a proximal section with a proximal end secured to a respective one of the central bodies 24 of the scaffolding pipe coupling device 14. The L-shaped jaws 28 can be secured by any suitable method including but not limited to welding and mechanical fasteners such as bolts. In the embodiment shown, the L-shaped jaws 28 are secured to the central body 24 of the scaffolding pipe coupling device 14 through bolts 29 extending in apertures defined in the lateral walls of the central body 24 and in apertures defined in the proximal section of the L-shaped jaw 28. In the embodiment shown, the bolts 29 also act as the hinge for the clamping arms 26 of the scaffolding pipe coupling device 14 and define the pivot axis 27.

A distal section of the L-shaped jaw 28, extending substantially perpendicular to the proximal section of the L-shaped jaw 28, has a threaded hole defined therein through which a threaded fastener such as a clamping bolt 30 is inserted and can translate therein by rotation.

The L-shaped jaws 28 are spaced apart from one another with their distal sections oriented inwardly, i.e. towards one another. Thus, each one of the jaws 28 is located on a respective side of the beam 22 coupled therewith.

One skilled in the art will appreciate that the shape, the configuration, and the components of the sections of the beam coupling device 18 can vary from the embodiment shown in the accompanying drawings.

For coupling the beam 22, flange sections 32 of the beam 22 are inserted between the central bodies 24 of the scaffolding pipe coupling device 14 and the L-shaped jaws 28. The bolts 30 are screwed until their tips abut an inner face of the flange 20, opposed to the outer face, and apply pressure thereon. The flange 20 is maintained firmly (or squeeze) between the tip of the bolts 30 and the central bodies 24. An outer face of the flanges 20 abuts the central bodies 24. The beam 22 is thus secured to the scaffolding beam coupler 10 by the two sections of the beam coupling device 18, each one extending on a respective side of the beam 22 and, more particularly, its web 23. For releasing the beam 22, the bolts 30 are unscrewed until the flange 20 can be removed from the beam coupling device 18.

In the embodiment, the scaffolding pipe coupling device 14 and the beam coupling device 18 are releasable coupling devices, i.e. the beam 22 or the scaffolding pipe 16 can be released from the coupling devices. However, in an alternative embodiment (not shown), one or both coupling devices 14, 18 can be permanent coupling devices.

To prevent the sections of the beam coupling device 18 from moving apart from one another and, more particularly, the L-shaped jaws 28, the beam coupling device 18 further includes two transversal members 34, each one of the transversal members 34 extends between the two L-shaped jaws 28 and is connected thereto through two support arms 36 as it will be described in more details below.

The two sections 12 of the scaffolding beam coupler 10 are connected together through the transversal members 34.

In the embodiment shown, two support arms 36 are secured and, in the embodiment shown, welded to their respective and adjacent L-shaped jaw 28 and central body 24. The support arms 36 are connected to the proximal section of the L-shaped jaws 28. Thus, each one of the support arms 36 is associated to a respective one of the sections 12 of the beam coupling device 18. The support arms 36 are substantially parallel to one another and spaced-apart from one another. They extend substantially parallel to the beam 22, to which the scaffolding beam coupler 10 is engaged. In the embodiment shown, the support arms 36 extend outwardly past the L-shaped jaws 28, on each side thereof. The transversal members 34 are secured to the support arms 36 in the sections extending outwardly past the L-shaped jaws 28. More particularly, each one of the support arms 36 has two bores extending therethrough, each one of the bores being provided at a respective end of the support arms 36, in the sections extending outwardly past the L-shaped jaws 28. Each one of the bores defined in one of the support arms 36 is in register with a respective one of the bores defined in the other one of the support arms 36.

The transversal members 34 extend through two bores in register and defined in the two spaced-apart support arms 36. More particularly, the transversal members 34 extend between the two support arms 36 and connect together the two sections 12 of the scaffolding beam coupler 10. The transversal members 34 extend substantially perpendicularly to the support arms 36 and the beam 22 engageable with the beam coupling device 18. As mentioned above, the transversal members 34 prevent the sections of the beam coupling device 18, including the L-shaped jaws 28, from moving apart from one another and thereby releasing the beam 22 secured therebetween. More particularly, they prevent the sections of the beam coupling device 18, including the L-shaped jaws 28, from moving apart from one another by connecting the two sections 12 of the scaffolding beam coupler 10 together.

When coupled with the beam 22, the flange 20 of beam 22 extends between the transversal members 34 and the distal section of the L-shaped jaws 28. As shown in FIG. 3, a free space is provided between the inner face of the flange 20 and the distal section of the L-shaped jaws 28 since the head of the bolts 30 abut the inner face of the flange 20. The outer face of the flange 20 abuts the transversal members 34 and the support arms 36, if any.

In the embodiment shown and as mentioned above, the support arms 36 are welded to their respective and adjacent L-shaped jaw 28 and central body 24. One skilled in the art will appreciate that, in alternative embodiments (not shown), the support arms 36 can be secured to one of the adjacent L-shaped jaw 28 and central body 24 or to other suitable component(s) of the scaffolding beam coupler 10. Furthermore, other suitable methods can be used for securing the support arms 36 to the scaffolding beam coupler 10. For instance and without being limitative, the support arms 36 can be secured to the scaffolding beam coupler 10 through mechanical fasteners such as bolts.

Furthermore, in the embodiment described above, the transversal members 34 are connected to the two support arms 36. However, one skilled in the art will appreciate that in an alternative embodiment, the transversal members 34 can be connected to other components of the scaffolding beam coupler 10. For instance and without being limitative, they can be connected directly to the jaws 28 (instead of indirectly through the support arms 36). For instance, the transversal members 34 can be secured directly to the proximal section of the L-shaped jaws 28. They can be either welded or fastened to the L-shaped jaws 28 and extend between two sections of the beam coupling device 18, i.e. the two spaced-apart jaws 28.

Furthermore, in the embodiment described above, the transversal members 34 are connected to the support arms 36 by extending through two bores defined therein. However, one skilled in the art will appreciate that in alternative embodiments (not shown), the support arms 36 can be secured by any suitable technique including but not limited to welding.

The scaffolding beam coupler 10 further includes a link member 38 couplable (linkable or securable) to the two transversal members 34 and engageable over the scaffolding pipe 16 inserted in the scaffolding pipe coupling device 14. In the embodiment shown, the link member 38 is a flexible cable surrounding both transversal members 34, between the two L-shaped jaws 28, and extending over the scaffolding pipe 16. The link member 38 maintains the coupling between the scaffolding pipe 16 and the beam 22 if the scaffolding pipe 16 is inadvertently released from the scaffolding pipe coupling device 14, i.e. if the clamps 14 open.

One skilled in the art will appreciate that other link members 38 can be used. For instance and without being limitative, the link member can be a flexible chain or a relatively stiff U-shaped member engaged with both transversal members 34. Furthermore, more than one link member 38 can be engaged with the transversal members 34 and extend over the scaffolding pipe 16. In the embodiment shown, the link member 38 extends over two parallel scaffolding pipes 16, 16a. However, in an alternative embodiment (not shown), the link member 38 can extend over only one of the scaffolding pipe 16, i.e. the one engaged with the scaffolding pipe coupling device 14. In still another alternative embodiment (not shown), more than two scaffolding pipes can be superposed and the link member 38 can extend over any one of the superposed scaffolding pipes.

One skilled in the art will appreciate that the weight-bearing structural element can be either the beam 22 or the scaffolding pipe 16. If the weight-bearing structural element is the beam 22, i.e. the beam 22 is an overhead beam, the beam 22 extends above the scaffolding pipe 16 and the scaffolding beam coupler 10 is mounted upside down. If the weight-bearing structural element is the scaffolding pipe 16 as in the embodiment described above, the beam 22 extends below the scaffolding pipe 16 as shown in the accompanying drawings.

As it is known in the art, the beam 22 can support a monorail M displaceable therealong.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention. The scope of the invention is therefore intended to be limited solely by the scope of the appended claims.

1. A scaffolding beam coupler for coupling a scaffolding pipe and a beam having a flange with two flange sections, the scaffolding beam coupler comprising:
a beam coupling device including at least two spaced-apart jaws engageable with the flange of the beam, each one of the spaced-apart jaws being engageable with a respective one of the flange sections for securing the beam to the beam coupling device; and
at least two transversal members, each one of the transversal members being connected to two of the spaced-apart jaws and extending therebetween, and at least two of the transversal members being spaced-apart from one another and preventing the connected spaced-apart jaws from moving apart when coupled with the beam.

2. A scaffolding beam coupler as claimed in claim 1, further comprising a scaffolding pipe coupling device releasably engageable with the scaffolding pipe and at least one link member couplable to at least two of the transversal members and engageable over the scaffolding pipe engaged with the scaffolding pipe coupling device.

3. A scaffolding beam coupler as claimed in claim 2, wherein the at least one link member comprises at least one of a flexible chain or a flexible cable, securable to the at least two of the transversal members and surrounding the scaffolding pipe engaged with the scaffolding pipe coupling device.

4. A scaffolding beam coupler as claimed in claim 1, wherein the at least two transversal members extend substantially perpendicular to the beam when releasably engaged with the beam coupling device.

5. A scaffolding beam coupler as claimed in claim 1, wherein the at least two transversal members are adjacent to an outer face of the flange of the beam releasably engaged with the beam coupling device.

6. A scaffolding beam coupler as claimed in claim 1, wherein the jaws are substantially L-shaped jaws and have a proximal section and a distal section and the distal sections of the at least two spaced-apart jaws are oriented inwardly and the at least two transversal members are connected to the proximal section of the L-shaped jaws.

7. A scaffolding beam coupler as claimed in claim 6, wherein each one of the at least two spaced-apart jaws extends on a respective side of a web of the beam releasably engaged with the beam coupling device and the flange of the beam extends between the at least two transversal members and the distal section of the jaws, when engaged therewith.

8. A scaffolding beam coupler as claimed in claim 6, further comprising support arms mounted to the beam coupling device, each one of the support arms being connected to a respective one of the L-shaped jaws.

9. A scaffolding beam coupler as claimed in claim 8, wherein the support arms extend outwardly past the L-shaped jaws, on each side thereof, and substantially parallel to the beam releasably engaged with the beam coupling device and the at least two transversal members are secured to the support arms on sections extending outwardly past the L-shaped jaws.

10. A scaffolding beam coupler as claimed in claim 8, wherein the support arms are adjacent to an outer face of the flange of the beam releasably engaged with the beam coupling device.

11. A scaffolding beam coupler as claimed in claim 8, wherein the at least two transversal members extend through bores defined in the support arms.

12. A scaffolding beam coupler as claimed in claim 6, wherein at least two spaced-apart jaws comprise two spaced-apart jaws and wherein the beam coupling device further comprises threaded fasteners engaged with the distal sections of the L-shaped jaws and translatable by rotation for either squeezing or releasing the flange sections of the beam releasably engageable with the beam coupling device.

13. A method for manufacturing a scaffolding beam coupler comprising:
providing a scaffolding beam coupler including a scaffolding pipe coupling device configured for engaging and securing a scaffolding pipe and a beam coupling device including at least two spaced-apart jaws engageable with a flange of a beam; and
connecting at least two transversal members to the jaws, each one of the transversal members being connected to two of the spaced-part jaws and being spaced apart from one another and preventing the jaws from moving apart when engaged with the beam.

14. A method as claimed in claim 13, further comprising: coupling at least one link member to one of the transversal members, the at least one link member being couplable with at least another one of the transversal members and extendable over a scaffolding pipe engaged with the scaffolding pipe coupling device.

15. A method as claimed in claim 14, wherein the at least one link member comprises at least one of a flexible chain or a flexible cable and said coupling further comprises securing the at least one link member to at least two of the transversal members and surrounding the scaffolding pipe engaged with the scaffolding pipe coupling device with the at least one link member.

16. A method as claimed in claim 13, wherein the at least two transversal members extend substantially perpendicular to the beam releasably engaged with the beam coupling device and the jaws are substantially L-shaped jaws and have a proximal section and a distal section and the distal sections of the at least two spaced-apart jaws are oriented inwardly and wherein the connecting comprises connecting the at least two transversal members with the proximal section of the L-shaped jaws.

17. A method as claimed in claim 13, further comprising securing support arms to the beam coupling device, each one of the support arms being connected to a respective one of the L-shaped jaws and wherein the support arms extend outwardly past the L-shaped jaws, on each side thereof, and wherein connecting the at least two transversal members further comprises securing the at least two transversal members to the support arms on sections extending outwardly past the L-shaped jaws.

18. A method as claimed in claim 17, wherein the support arms extend substantially parallel to the beam releasably engaged with the beam coupling device and spaced-apart from one another and securing the at least two transversal members further comprises performing bores in the support arms and inserting the at least two transversal members into the bores defined in the two spaced-apart support arms.

19. A method for coupling a scaffolding pipe and a beam having a flange, the method comprising:
providing a scaffolding beam coupler comprising a scaffolding pipe coupling device, a beam coupling device including at least two spaced-apart jaws engageable with the flange of the beam, and at least one transversal member connected to two of the spaced-apart jaws and preventing the connected jaws from moving apart when engaged with the beam;
engaging the scaffolding pipe with the scaffolding pipe coupling device; and
engaging the flange of the beam between the spaced-apart jaws.

20. A method as claimed in claim 19, further comprising providing at least one link member having two opposed ends and coupling the two ends of the at least one link member to the at least one transversal member with the at least one link member extending over the scaffolding pipe engaged with the scaffolding pipe coupling device.

21. A method as claimed in claim 20, wherein the at least one transversal member comprises at least two transversal members and the at least one link member comprises at least one of a flexible chain or a flexible cable and said coupling further comprises securing the at least one link member to two of the transversal members and surrounding the scaffolding pipe engaged with the scaffolding pipe coupling device with the at least one link member.

22. A method as claimed in claim 19, wherein the at least one transversal member extends substantially perpendicular to the beam releasably engageable with the beam coupling device.

23. A method as claimed in claim 19, wherein the at least one transversal member is adjacent to an outer face of the flange of the beam releasably engaged with the beam coupling device.

24. A method as claimed in claim 19, wherein the at least two spaced-apart jaws comprises two spaced-apart jaws and the jaws are substantially L-shaped jaws and have a proximal section and a distal section and the distal sections of the spaced-apart jaws are oriented inwardly, and the at least one transversal member is connected to the proximal section of the L-shaped jaws and wherein each one of the spaced-apart jaws extends on a respective side of a web of the beam releasably engaged with the beam coupling device and the flange of the beam extends between the at least one transversal member and the distal section of the jaws.

25. A method as claimed in claim 24, further comprising support arms mounted to the beam coupling device, each one of the support arms being secured to a respective one of the L-shaped jaws, the support arms extending outwardly past the L-shaped jaws, on each side thereof, and the at least one transversal member being secured to the support arms on a section extending outwardly past the L-shaped jaws.

26. A method as claimed in claim 25, wherein the support arms extend substantially parallel to the beam releasably engageable with the beam coupling device and are adjacent to an outer face of the flange of the beam releasably engaged with the beam coupling device.

27. A method as claimed in claim 19, wherein engaging the scaffolding pipe with the scaffolding pipe coupling device comprises securing the scaffolding pipe with the scaffolding pipe coupling device and engaging the flange of the beam between both spaced-apart jaws comprises securing the flange of the beam between both spaced-apart jaws.

28. A scaffolding beam coupler for coupling a scaffolding pipe and a beam having a flange with two flange sections, the scaffolding beam coupler comprising two scaffolding beam coupler sections, each having a beam coupling device with at least one jaw engageable with one of the flange sections of the beam for securing the beam to the scaffolding beam coupler, the at least one jaw of one of the scaffolding beam coupler sections being spaced-apart from the at least one jaw of the other one of the scaffolding beam coupler sections, and the two scaffolding beam coupler sections being connected together for preventing the spaced-apart jaws from moving apart when coupled with the beam.

29. A scaffolding beam coupler as claimed in claim 28, further comprising at least one transversal member connected to the spaced-apart jaws and preventing the spaced-apart jaws from moving apart when coupled with the beam.

30. A scaffolding beam coupler as claimed in claim 29, further comprising providing at least one link member having two opposed ends and coupling the two ends of the at least one link member to the at least one transversal member with the at least one link member extending over the scaffolding pipe engaged with the scaffolding pipe coupling device.

31. A scaffolding beam coupler as claimed in claim 30, wherein the at least one transversal member comprises at least two transversal members and the at least one link member comprises at least one of a flexible chain or a flexible cable, securable to the at least two of the transversal members and surrounding the scaffolding pipe engaged with the scaffolding pipe coupling device.

32. A scaffolding beam coupler as claimed in claim 29, wherein the at least one transversal member extends substantially perpendicular to the beam and is adjacent to an outer face of the flange of the beam when releasably engaged with the beam coupling device.

33. A scaffolding beam coupler as claimed in claim 29, wherein the jaws are substantially L-shaped jaws and have a proximal section and a distal section and the distal sections of the at least two spaced-apart jaws are oriented inwardly and the at least one transversal member is connected to the proximal section of the L-shaped jaws.

34. A scaffolding beam coupler as claimed in claim 33, wherein each one of the at least two spaced-apart jaws extends on a respective side of a web of the beam releasably engaged with the beam coupling device and the flange of the beam extends between the at least one transversal member and the distal section of the jaws, when engaged therewith.

35. A scaffolding beam coupler as claimed in claim 33, further comprising support arms mounted to the beam coupling device, each one of the support arms being connected to a respective one of the L-shaped jaws and the support arms extending outwardly past the L-shaped jaws, on each side thereof, and being substantially parallel to the beam releasably engaged with the beam coupling device, the at least one transversal member being secured to the support arms on a section extending outwardly past the L-shaped jaws, and the support arms being adjacent to an outer face of the flange of the beam releasably engaged with the beam coupling device.
